(19) United States
(12) Patent Application Publication
(10) Pub. No.: US 2007/0161517 A1
(43) Pub. Date: Jul. 12, 2007

(54) Silicone grease composition

(75) Inventors: Ching-Tai Cheng, Tu-Cheng (TW); Nien-Tien Cheng, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Foxconn Technology Co., Ltd., Tu-Cheng (TW)

(21) Appl. No.: 11/309,914

(22) Filed: Oct. 27, 2006

(30) Foreign Application Priority Data
Dec. 23, 2005 (CN) 200510121201.8

(51) Int. Cl. C10M 169/04; B01D 19/04

(52) U.S. Cl. 508/154; 508/202

(57) ABSTRACT

A silicone grease composition includes approximately 5 to 50% by weight of liquid organopolysiloxane, 45 to 94.9% by weight of a thermally conductive filler, and 0.1 to 5% by weight of a coupling agent chosen from at least one of a titanate-based coupling agent and an aluminate-based coupling agent. Due to the presence of the coupling agent, the silicone grease composition has a relatively lower viscosity and thus is capable of containing a larger amount of the filler whereby the thermally conductive efficiency of the composition is accordingly improved.

### FIELD OF THE INVENTION

The present invention relates generally to a silicone grease composition, and more particularly to a silicone grease composition capable of containing a larger amount of thermally conductive filler and having a lower viscosity.

### DESCRIPTION OF RELATED ART

With the fast development of the electronics industry, silicone grease compositions have been widely applied in the field of heat dissipation. The silicone grease compositions generally comprise liquid organopolysiloxane and thermally conductive filler filled in the liquid organopolysiloxane. The thermally conductive filler has good thermally conductive property, and the liquid organopolysiloxane is capable of eliminating air gaps formed between a heat dissipation component such as a heat sink and a heat-generating electronic component such as a central processing unit (CPU) when the silicone grease composition is applied between the heat dissipation component and the heat-generating electronic component. In order to improve the thermally conductive efficiency of the silicone grease composition, the amount of the thermally conductive filler needs to be increased.

The thermally conductive filler increases the thermal conductivity of the silicone grease composition. However, the viscosity of the liquid organopolysiloxane increases with an increase in the mount of the thermally conductive filler in the composition. A silicone grease composition having a high viscosity cannot effectively eliminate the air gaps between the heat dissipating component and the heat-generating electronic component. As a result, the heat dissipation component fails to intimately contact with the heat-generating electronic component.

Therefore, it is desirable to provide a silicone grease composition which can overcome the above-mentioned disadvantage.

### SUMMARY OF THE INVENTION

The present invention relates to a silicone grease composition. The silicone grease composition includes approximately 5 to 50% by weight of liquid organopolysiloxane, approximately 45 to 94.9% by weight of a thermally conductive filler, and approximately 0.1 to 5% by weight of a coupling agent chosen from the group consisting of a titanate-based coupling agent and an aluminate-based coupling agent.

Other advantages and novel features of the present invention will become more apparent from the following detailed description of preferred embodiment.

### DETAILED DESCRIPTION OF THE INVENTION

The present silicone grease composition, which is intended to be applied between a heat-generating electronic component such as a CPU and a heat dissipation component such as a heat sink, includes liquid organopolysiloxane, a thermally conductive filler and a coupling agent.

The liquid organopolysiloxane is approximately 5 to 50% by weight of the silicone grease composition. The liquid organopolysiloxane has a viscosity in an approximate range from 50 to 50,000 cs at about 25° C. The liquid organopolysiloxane is capable of eliminating air gaps formed between the heat dissipation component and the heat-generating electronic component, so as to decrease a thermal resistance therebetween.

The thermally conductive filler is approximately 45 to 94.9% by weight of the silicone grease composition, and is chosen from a metal powder having an average particle size in an approximate range from 0.5 to 10 μm, a metal oxide having an average particle size in an approximate range from 0.1 to 5 μm, or a combination of the aforementioned materials. The metal powder can typically be selected from highly thermally conductive material such as copper powder, aluminum powder, zinc powder or a combination of at least two of the aforementioned materials. The metal oxide is typically selected from highly thermally conductive material such as alumina, zinc oxide or a combination of the two oxides. For example, the thermally conductive filler may include approximately 45 to 94.9% by weight of a metallic aluminum powder and approximately 0 to 30% by weight of a metal oxide selected from the group consisting of zinc oxide and alumina.

The coupling agent forms approximately 0.1 to 5% by weight of the silicone grease composition. The coupling agent is chosen from a titanate-based coupling agent, an aluminate-based coupling agent, or a combination of the aforementioned coupling agents. The titanate-based coupling agent is chosen from isopropyltriisostearoyl titanate, isopropyltris(dioctylpyrophosphate) titanate, isopropyltri(N-aminoethyl-aminoethyl) titanate, tetraoctylbis(ditridecylphosphate) titanate, tetra(2,2-diallyloxymethyl-1-butyl)bis(ditridecyl)-phosphite titanate, bis(dioctylpyrophosphate)oxyacetate titanate, bis(dioctylpyrophosphate)ethylene titanate, isopropyltrioctanoyl titanate, isopropyidimethacrylisostearoyl titanate, isopropyltridodecylbenzenesuphonyl titanate, isopropylisostearoyidiacryl titanate, isopropyltri(dioctylphosphate) titanate, isopropyltricumylphenyl titanate, or tetraisopropylbis(dioctylphosphite) titanate. The aluminate-based coupling agent is chosen from alkylacetoacetate aluminum di-isopropylate. When the thermally conductive filler is blended with liquid organopolysiloxane to obtain the present silicone grease composition, the coupling agent promotes the thermally conductive filler to disperse in the liquid organopolysiloxane. Therefore, the viscosity of the silicone grease composition is comparatively decreased and accordingly, a larger amount of the filler can be filled into the silicone grease composition without incurring an unduly high viscosity. As a result, when the silicone grease composition is applied between the heat-generating electronic component and the heat dissipation component, the silicone grease composition can intimately contact the heat-generating electronic component and the heat dissipation component, and the thermally conductive efficiency of the silicone grease composition is accordingly improved.

Referring to TABLE 1 below, a heat resistance comparison between the present silicone grease composition and a conventional silicone grease composition is shown. Within the same test requirements, i.e., in both of the examples, an aluminum powder which is about 73.5% by weight of the composition and a liquid organopolysiloxane which has a viscosity of about 30,000 cs are used, the present silicone grease composition with an added titanate-based coupling agent possesses much lower thermal resistance than the conventional silicone grease composition without the coupling agent.

TABLE 1

| | | Added | | | Thermal |
|---|---|---|---|---|---|
| | | amount of | Viscosity of the liquid | Titanate-based | resistance |
| | Filler | filler | organopolysiloxane | coupling agent | (° C. · cm²/W) |
| Present silicone | Al | 73.5 weight | 30,000 cs | 1 weight % | 0.263 |
| grease composition | | % | | | |
| Conventional | Al | 73.5 weight | 30,000 cs | 0 weight % | 0.860 |
| silicone grease | | % | | | |
| composition | | | | | |

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A silicone grease composition comprising:
approximately 5 to 50% by weight of liquid organopolysiloxane;
approximately 45 to 94.9% by weight of a thermally conductive filler; and
approximately 0.1 to 5% by weight of a coupling agent chosen from at least one of a titanate-based coupling agent and an aluminate-based coupling agent.

2. The silicone grease composition of claim 1, wherein a viscosity of the liquid organopolysiloxane is approximately 50 to 50,000 cs at about 25° C.

3. The silicone grease composition of claim 1, wherein the thermally conductive filler is chosen from at least one of a metal powder having an average particle size of about 0.5 to 10 μm and a metal oxide having an average particle size of about 0.1 to 5 μm.

4. The silicone grease composition of claim 1, wherein the thermally conductive filler includes approximately 45 to 94.9% by weight of a metallic aluminum powder having an average particle size in an approximate range from 0.5 to 10 μm and approximately 0 to 30% by weight of a metal oxide selected from the group consisting of zinc oxide and alumina having an average particle size of about 0.1 to 5 μm.

5. The silicone grease composition of claim 3, wherein the metal powder is selected from the group consisting of copper powder, aluminum powder, zinc powder and a combination of the aforementioned materials.

6. The silicone grease composition of claim 3, wherein the metal oxide is selected from the group consisting of aluminum oxide, zinc oxide and a combination of the aforementioned materials.

7. The silicone grease composition of claim 1, wherein the titanate-based coupling agent is chosen from at least one of isopropyltriisostearoyl titanate, isopropyltris(dioctylpyrophosphate) titanate, isopropyltri(N-aminoethyl-aminoethyl) titanate, tetraoctylbis(ditridecylphosphate) titanate, tetra(2,2-diallyloxymethyl-1-butyl)bis(ditridecyl)-phosphite titanate, bis(dioctylpyrophosphate)oxyacetate titanate, bis(dioctylpyrophosphate)ethylene titanate, isopropyltrioctanoyl titanate, isopropyidimethacrylisostearoyl titanate, isopropyltridodecylbenzenesuphonyl titanate, isopropylisostearoyidiacryl titanate, isopropyltri(dioctylphosphate) titanate, isopropyltricumylphenyl titanate, and tetraisopropylbis(dioctylphosphite) titanate.

8. The silicone grease composition of claim 1, wherein the aluminate-based coupling agent is chosen from alkylacetoacetate aluminum di-isopropylate.
